(19) United States
(12) Patent Application Publication
(10) Pub. No.: US 2005/0207349 A1
(43) Pub. Date: Sep. 22, 2005

(54) System and method for measuring quality of communication

(75) Inventors: Kenichi Nagami, Tokyo (JP); Ikuo Nakagawa, Tokyo (JP)

Correspondence Address: BIRCH STEWART KOLASCH & BIRCH, PO BOX 747, FALLS CHURCH, VA, 22040-0747, US

(73) Assignee: Intec NetCore, Inc.

(21) Appl. No.: 11/081,563

(22) Filed: Mar. 17, 2005

(30) Foreign Application Priority Data
Mar. 19, 2004 (JP) 2004-081753

(51) Int. Cl. H04J 3/14; H04J 1/16; H04L 1/00; H04L 12/26; H04L 12/66

(52) U.S. Cl. 370/241

(57) ABSTRACT

Measurement servers and a presentation server are provided such that, in an internet comprising a plurality of networks, a communication quality provided by each network in relation with another network can be measured and a user can grasp it with a bird's-eye view as required. Each of the measurement servers is located at each network, and the presentation server collects information from the measurement servers. Each measurement server sends a measurement packet toward another measurement server, receives a response to the measurement packet to acquire information about a network quality of communication with the other measurement server, and sends the acquired information to the presentation server. The presentation server shows a communication quality in accordance with an instruction from a user, based on the received information.

### BACKGROUND OF THE INVENTION

1. Field of the Invention

The present invention relates to a system for measuring a communication quality in an internetwork, which comprises a plurality of networks, in order to inform a user of the communication quality in accordance with a user's request.

2. Background

The Internet, which is a typical internetwork, is a distributed system of autonomous, interconnected networks, and a relay node (router) only performs a process to receive a packet, determine the next relay node based on a destination of the received packet, and forward the packet to the next node. Therefore, even if traffic flowing through a network is observed from a certain point, what is found is only a state of part of the Internet which can be seen from that point. If observed from another point, a completely different state will be seen.

For example, in a case of communication from a node (e.g., a user node) belonging to one Internet service provider (ISP) to a node (e.g., a certain server) belonging to another ISP, its quality can be measured (see Japanese Patent Laid-Open Application No. 2001-326642 for example). That is, a node belonging to one ISP can measure a quality of end-to-end communication from the node itself to a node belonging to another ISP. However, this conventional technique is just a measurement from the node itself as a center, and a communication quality between a node belonging to another ISP and a node belonging to further another ISP cannot be measured. Moreover, in a case where communication to an object node is via a plurality of ISP networks, a communication quality for each ISP network passed through cannot be evaluated separately by the conventional technique.

Similarly, in a case where one user network (corporate network, SOHO (Small Office/Home Office) network, Home network, etc.) is provided with connections to the Internet by two or more ISPs (this is called “multi-home connection”), traffic between the user network and the first ISP cannot be observed from a node in the second ISP by the conventional technique.

Quality control on the Internet like this is extremely difficult when compared to conventional centrally-controlled telephone networks because of the large scale, diversity, distributed management, etc. of the Internet. However, a demand for quality control is growing day by day, and some ISPs have come to provide a service quality assurance service called a Service Level Agreement (SLA). An SLA guarantees that a quality of communication within a network of an ISP itself is kept higher than or equal to a certain level, and makes compensation such as returning part of a connection fee to a user in case a communication quality becomes worse than the guaranteed level. However, this guarantees a communication quality only within the one ISP network, so a quality of communication with a node belonging to another ISP is not guaranteed.

Under the above circumstances, several arts have been proposed separately. For example, one art is proposed in which, by making a relay node located between two networks, e.g., an access network and a backbone network, monitor a data packet that is forwarded from a node belonging to the access network to a node belonging to the backbone network, both of a delay in communication from the access network node to the relay node and a delay in communication from the relay node to the backbone network node are measured (see Japanese Patent Laid-Open Application No. 2002-374301), and another art is proposed in which a communication performance between any client node and any server node is estimated by communicating with a junction node that exists on the path, regardless of a position where a measurement node is located (see Japanese Patent Laid-Open Application No. 2003-8648).

Proposed arts like the above are all built on the assumption that communication between end nodes is via the same relay node or junction node in both ways. However, in typical routing control of the Internet (e.g., in the above backbone network in a case where the backbone network comprises a plurality of networks), a forward path of a packet going from one node A to another node B and a forward path of a packet returning from the node B to the node A are not controlled to pass through the same router, and are positively allowed to pass through different routes. For this reason, the above-described proposed arts assuming that the same path is used can only be applied, in the Internet, to a very limited area.

Moreover, in the above-described proposed arts, when a forward path of a packet going from one node A to another node B is via a plurality of networks, a communication quality of each network cannot be measured even though an end-to-end (e.g., between a relay node at an entrance of the above backbone network and a subscriber node at a destination) communication delay and communication performance can be found. Furthermore, since the Internet is managed separately by many organizations (e.g., each ISP), it is difficult to get measurement data of another organization. Even if a measurement packet defined by a specification of the Internet is sent to a node (router or host) managed by another organization, the packet is often discarded in an operation in the other organization and a response required for measurement cannot be obtained.

### SUMMARY OF THE INVENTION

Systems and methods consistent with the invention can measure a communication quality from the viewpoint of what communication quality each network can provide in relation to another network, in an internetwork comprising a plurality of networks (e.g., ISP networks), and can show a measurement result so that a user can grasp a communication quality of the internetwork with a bird's-eye view as required. A user of a system and method consistent with the invention may be, for example, a manager of a user network (corporate, SOHO, home, etc.) connected to the Internet, an individual user who is provided with an Internet connection by an ISP, etc. A manager of an ISP may also be the user in a case where, for example, ISPs plan to provide more extensive or detailed SLAs (e.g., assuring a quality of communication with another ISP network in some way, assuring a quality for each further-divided section in an ISP's own network, etc.) in order to attract customers. A company that installs a server in the Internet and provides its client with some type of communication service may also be the user.

Systems and methods consistent with the invention provide a measurement system connected with a plurality of networks. The measurement system comprises a plurality of measurement servers, each of which is located at each of the plurality of networks, and a presentation server that collects information from the plurality of measurement servers and shows the information to a user. Each measurement server transmits a measurement packet toward a node belonging to another of the plurality of networks, acquires information regarding a quality of communication with the node based on a response to the measurement packet, and transmits to the presentation server the information acquired. The presentation server receives the information transmitted from each of the plurality of measurement servers, and informs the user of a communication quality in accordance with an instruction from the user, based on the information received.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

The accompanying drawings are incorporated in and constitute a part of this specification. The drawings exemplify certain aspects of the invention and, together with the description, serve to explain some principles of the invention.

FIG. 1 shows an example of a network configuration to which first and second embodiments of the invention may be applied;

FIG. 2 shows an internal configuration example of a measurement server and a presentation server consistent with the first embodiment of the invention;

FIG. 3 shows an example of information shown to a user in the first embodiment of the invention;

FIG. 4 shows an internal configuration example of a measurement server and a presentation server consistent with the second embodiment of the invention;

FIG. 5 shows an example of information shown to a user in the second embodiment of the invention;

FIG. 6 shows an example of a network configuration to which a third embodiment of the invention may be applied;

FIG. 7 shows an internal configuration example of a measurement server and a presentation server consistent with the third embodiment of the invention;

FIG. 8 shows an example of information shown to a user in the third embodiment of the invention; and

FIG. 9 shows an example of conventional communication quality measurement in the Internet.

### DETAILED DESCRIPTION

The following detailed description refers to the accompanying drawings. Although the description includes exemplary implementations, other implementations are possible and changes may be made to the implementations described without departing from the spirit and scope of the invention. The following detailed description and the accompanying drawings do not limit the invention. Instead, the scope of the invention is defined by the appended claims.

### General Description

A first measurement system consistent with the invention, connected with a plurality of networks, comprises: a plurality of measurement servers, each of which is located at each of the plurality of networks; and a presentation server that collects information from the plurality of measurement servers and shows the information to a user. Each of the plurality of measurement servers includes: a first transmitting unit that transmits a measurement packet toward a node belonging to another of the plurality of networks (the node may be a measurement server installed in another network, or may be a router or host belonging to another network); an acquiring unit that acquires information regarding a quality of communication with the node based on a response to the measurement packet; and a second transmitting unit that transmits the acquired information to the presentation server. The presentation server includes: a receiving unit that receives the information regarding a quality of communication from each of the plurality of measurement servers; and an informing unit that informs a user of a quality provided on communication starting from each of the plurality of measurement servers, in accordance with an instruction from the user, based on the received information.

This configuration allows a user to grasp a communication quality provided between each point (a measurement server and a measurement server, and/or a measurement server and a node) over a plurality of networks when the user sends a certain presentation server an instruction that the user wants to know a communication quality of an internetwork. That is, while with conventional arts only a so-called star formed observation can be done in which a quality of communication with each node to be measured is measured from a user node as a center, the above configuration allows a full mesh observation to be done between each measurement server on a plurality of networks, each of which is provided with a measurement server, regardless of which network a user node or a presentation server belongs to (in a case where measurement is performed between measurement servers). Alternatively, a quality of communication between each network can be grasped in a close-to-full-mesh form by gathering results of a plurality of star formed observations which are done from each of a plurality of measurement servers as a center (in a case where measurement is performed between a measurement server and a node).

In the above configuration, a presentation server may be as follows: it always collects all measurement data from each measurement server, and when instructed by a user, it selectively shows part of the collected information as required by the user. That is, a presentation server acts as a frontend of a system that collectively measures a communication quality of an internetwork, and can accept instructions from many users to show required information for each user based on measurement data which are always collected, so that it is superior in scalability when compared to a case where each user measures in person one by one.

In addition, in the above configuration, so-called active measurement is performed in which each measurement server sends a measurement packet to receive a response to it. Therefore, a communication quality can be measured even if a forward path of an outgoing packet is different from that of an incoming packet. That is, for example, if active measurement is performed by a measurement server A on a measurement server B, a communication quality of an outgoing forward path from a point A to a point B can be obtained, and if active measurement is performed by the measurement server B on the measurement server A, a communication quality of an incoming forward path from the point B to the point A can be obtained. Moreover, in the above configuration, if an administrator of a presentation server (e.g., a disinterested organization independent of each ISP) is permitted, in a unified way, by an administrator of each network (e.g., each ISP) to install a measurement server and send measurement traffic in there, a situation can be eliminated where a measurement packet is discarded and measurement becomes impossible.

A second measurement system consistent with the invention, connected with a plurality of networks, comprises: a plurality of measurement servers, each of which is located at each of the plurality of networks; and a presentation server that collects information from the plurality of measurement servers and shows the information to a user. Each of the plurality of measurement servers includes: a first transmitting unit that transmits a measurement packet toward a node belonging to another of the plurality of networks (the node may be a measurement server installed in another network, or may be a router or host belonging to another network); an acquiring unit that acquires information regarding a quality of communication with the node and a path of packet forwarding based on a response to the measurement packet; and a second transmitting unit that transmits the acquired information to the presentation server. The presentation server includes: a receiving unit that receives the information regarding a quality of communication and a path of packet forwarding from each of the plurality of measurement servers; and an informing unit that estimates a communication performance of a network indicated among the plurality of networks by a user, based on the received information, and informs the user of the estimated performance. Alternatively, each of the plurality of measurement servers may include: a first transmitting unit that transmits a measurement packet toward a node belonging to another of the plurality of networks; an acquiring unit that acquires information regarding a quality of communication with the node and a path of packet forwarding based on a response to the measurement packet; an estimating unit that estimates a communication performance of a part of the plurality of networks, based on the acquired information regarding a quality of communication and a path of packet forwarding; and a second transmitting unit that transmits the estimated information regarding a communication performance to the presentation server, and the presentation server may include: a receiving unit that receives the information regarding a communication performance from each of the plurality of measurement servers; and an informing unit that informs a user of a communication performance of a network indicated by the user, based on the received information.

While the first system consistent with the invention allows a user to grasp a communication quality provided between each point (a measurement server and a measurement server, and/or a measurement server and a node) over a plurality of networks, the second system consistent with the invention allows a user to know an estimated communication performance of each network by collecting additional information regarding which packet forwarding path provides the communication quality between each point. As the communication performance of each network, a communication performance of each network with another network, such as which of a network B and a network C can provide a superior communication quality to reach a network A, can also be estimated.

Therefore, the second system allows a user to grasp a performance of communication from an indicated network to another network, a communication performance that another network can provide for an indicated network, or the like. In addition, the second system has a good scalability and can use the advantage of active measurement, as well as the first system.

A third measurement system consistent with the invention, connected with a plurality of networks, comprises: a plurality of measurement servers, each one or more of which is located at each of the plurality of networks; and a presentation server that collects information from the plurality of measurement servers and shows the information to a user. Each of the plurality of measurement servers includes: a first transmitting unit that transmits a measurement packet toward another of the plurality of measurement servers that is located at a same or different network among the plurality of networks; an acquiring unit that acquires information regarding a quality of communication with said another of the plurality of measurement servers based on a response to the measurement packet; and a second transmitting unit that transmits the acquired information to the presentation server. The presentation server includes: an identifying unit that identifies one or more of the plurality of measurement servers existing on a path of packet forwarding within a measurement section indicated by a user, the measurement section being divided into sub-sections that form the path; and an informing unit that informs the user of a quality of communication for each of the sub-sections, based on information regarding a quality of communication received from the identified one or more of the plurality of measurement servers.

In this configuration, when a user sends a certain presentation server an instruction regarding a section (a start point and an endpoint) whose communication quality the user wants to know, a packet forwarding path of the section is divided into a plurality of sub-sections and the user can grasp a communication quality of each sub-section on the path. That is, a user can get to know a communication quality between selected points, for each sub-section on the path, regardless of which network a user node or a presentation server belongs to. The sub-section can be put between two measurement servers. The sub-section may be between one border and another border of one network, may be between one point and another point in one or more networks, or may be a link connecting one network with another network. As is the case with the first and second systems, the third system has a good scalability and can use the advantage of active measurement.

While the second system consistent with the invention can estimate and show a communication performance of one network as a network being on a route to another network, the third system consistent with the invention can actually measure a communication quality of a section passing through a plurality of networks, dividing them into each network to pass through. Therefore, for example, the second system can be used in a case where a user wants to know a communication performance as a general tendency of each network, and the third system can be used in a case where a user, when a communication quality of a certain section is significantly degraded, wants to know by actual measurement which network is the cause.

In the first to third systems, the plurality of measurement servers may transmit information regarding a quality of communication to the presentation server, by turns or periodically. This allows a presentation server to always collect updated information on a communication quality. Alternatively, the presentation server may select one or more of the plurality of measurement servers in accordance with an instruction from the user, and may transmit a request for information regarding a quality of communication to the selected one or more of the plurality of measurement servers, and the plurality of measurement servers may transmit information regarding a quality of communication to the presentation server, in response to the request from the presentation server. This allows a presentation server to collect information on a communication quality as required.

In the first to third systems, communication between the presentation server and each of the plurality of measurement servers may be associated with authentication and encryption. This allows a presentation server to use received information on a communication quality for presentation only when the information is verified that it is sent from a genuine measurement server installed in each network. Moreover, when sending information about a communication quality in response to a request from a presentation server, each measurement server can verify whether the request is sent from a genuine presentation server (e.g., a presentation server of the above-described disinterested organization) or not, so that information about a communication quality is protected from being collected fraudulently by a false server.

The first to third systems can be realized not only as an invention of the above-described measurement system, but also as an invention of a presentation server alone, or as an invention of a measurement method, or as an invention of a program for making a computer function as a presentation server of the above configuration, or as an invention of a program for making each measurement server and presentation server execute the above measurement method.

For example, methods consistent with the invention may be performed in a measurement system connected with a plurality of networks and including a plurality of measurement servers and a presentation server. The first measurement method comprises: transmitting, by at least one of the plurality of measurement servers, a measurement packet toward a node belonging to another of the plurality of networks, each of the plurality of measurement servers being located at each of the plurality of networks; acquiring, by said at least one of the plurality of measurement servers, information regarding a quality of communication with the node based on a response to the measurement packet; receiving, by the presentation server, the acquired information from said at least one of the plurality of measurement servers; and informing, by the presentation server, a user of a quality provided on communication starting from said at least one of the plurality of measurement servers, in accordance with an instruction from the user, based on the received information. The second measurement method comprises: transmitting, by at least one of the plurality of measurement servers, a measurement packet toward a node belonging to another of the plurality of networks, each of the plurality of measurement servers being located at each of the plurality of networks; acquiring, by said at least one of the plurality of measurement servers, information regarding a quality of communication with the node and a path of packet forwarding based on a response to the measurement packet; estimating, by the presentation server or at least one of the plurality of measurement servers, a communication performance of a network indicated among the plurality of networks by a user, based on the acquired information; and informing, by the presentation server, the user of the estimated performance. The third measurement method comprises: transmitting, by at least one of the plurality of measurement servers, a measurement packet toward another of the plurality of measurement servers that is located at a same or different network among the plurality of networks, each one or more of the plurality of measurement servers being located at each of the plurality of networks; acquiring, by said at least one of the plurality of measurement servers, information regarding a quality of communication with said another of the plurality of measurement servers based on a response to the measurement packet; receiving, by the presentation server, the acquired information from said at least one of the plurality of measurement servers that exists on a path of packet forwarding within a measurement section indicated by a user, the measurement section being divided into sub-sections that form the path; and informing, by the presentation server, the user of a quality of communication for each of the sub-sections, based on the received information.

In the first to third systems and methods, measurable communication qualities include a throughput, a packet forwarding delay, delay fluctuations (jitter), a packet loss, bandwidth, reachability, or the like. Since any one or more of the above communication qualities may be used in systems and methods consistent with the invention, which one or more (or the whole) of them is to be measured can be determined by implementation. The plurality of networks in the first to third systems and methods do not need to be a plurality of networks which are distinguished from each other physically or topologically, and do not need to be a plurality of networks whose managers are different from each other. That is, when a user of a system and method consistent with the invention grasps an internetwork as being divided into a plurality of areas, each of the areas is regarded as one network. Borders between networks may be determined as the user likes according to the user's convenience.

In an internetwork comprising a plurality of networks, systems and methods consistent with the invention allows a communication quality provided by each network in relation to another network to be measured and shown so that a user can grasp it with a bird's-eye view as required. Specifically, with the first system and method, a communication quality provided between each point over a plurality of networks can be shown in a full mesh form or in a form of extraction from the full mesh. The second system and method estimate a communication performance of each network based on a communication quality obtained in the above full mesh form or close-to-full-mesh form, so that they can show not only a communication performance within one network, but also a communication performance of a network as a network through which communication reaches another network. With the third system and method, a communication quality provided on a section, from a start point to an end point, which passes through a plurality of sub-sections (networks or links) can be shown for each sub-section to pass through.

### Description with Reference to Drawings

Exemplary embodiments consistent with the invention will be described below with reference to the drawings.

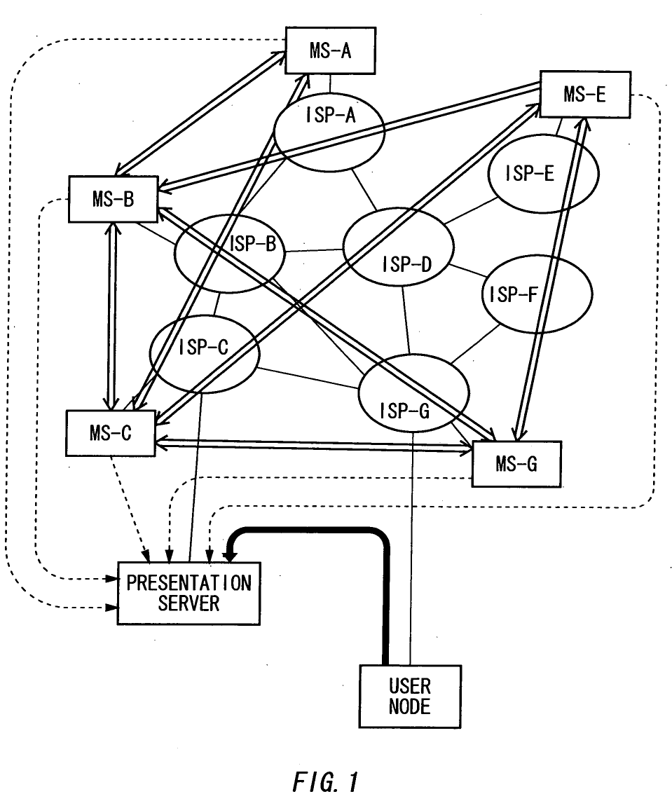

FIG. 1 illustrates a network configuration to which first and second embodiments consistent with the invention may be applied. ISP-A through ISP-G represent networks of internet service providers, and there are many routers (not shown) in each network to provide IP (Internet Protocol) communication. The provider networks are connected to each other also by the IP (Internet Protocol). In the figure, one line schematically signifies a connection between provider networks. This does not necessarily mean that networks are connected to each other by a physical link, but includes a case where a connection is provided by another network at the back including many routers not shown. By the way, a network topology as illustrated cannot usually be known physically, but only the existence of a connection between networks can be inferred by tracing a path through which a packet is forwarded from a node belonging to one ISP to a node belonging to another ISP. Additionally, though each network is of ISPs different from each other in the example of FIG. 1, some ISPs, ISP-A to ISP-C for example, may be operated by the same ISP-X, and each of the networks A to C may correspond to an area in ISP-X defined by the OSPF (Open Shortest Path First) or other routing protocols. Alternatively, all of the ISPs, ISP-A to ISP-G, may be operated by the same ISP. Each of the networks A to G does not necessarily have clear borders topologically between itself and another network. The extent or border of each network can be defined as a user likes.

Measurement servers MS-A to MS-G are installed in this internet. In the example of FIG. 1, MS-A, B, C, E, and G are installed in ISP-A, B, C, E, and G, respectively, and no measurement server is installed in ISP-D and F. A communication quality is measured by sending and receiving a measurement packet between each measurement server. In the example of FIG. 1, measurement is not performed for some reason between MS-A and MS-E and between MS-A and MS-G. As for communication between MS-B and MS-E, communication from B to E is measured, but communication from E to B is not measured. Even when there is a part that is not measured like this, communication qualities provided on various places in the whole internet comprising ISPs, ISP-A to ISP-G, can be known with a bird's-eye view if measurement data can be collected from a sufficient number of measurement servers. In order to further increase the amount of data to be collected, two or more measurement servers may be installed in one ISP network.

In the example of FIG. 1, measurement packets are sent and received between measurement servers, but similar observation can be made by sending a measurement packet from a measurement server of one ISP to a node (router or host) of another ISP. For example, if MS-A sends a measurement packet to a node belonging to ISP-C and MS-C sends a measurement packet to a node belonging to ISP-A, measurement data can be obtained in almost the same way as when measurement packets are sent and received between MS-A and MS-C. However, in a case where a destination of a measurement packet is a measurement server, measurement packets are sent from both sides, so that a one-way delay or the like can be measured as a communication quality. In this respect, measurement data can be obtained more than a case where a destination is a node other than a measurement server. Incidentally, a node to be a destination of a measurement packet has at least a measurement packet receiving function, that is, a function to send back a response packet in response to a measurement packet.

A measurement server performs so-called active measurement in which test traffic (ping, traceroute, etc.) is sent and received so that measurement information is obtained as a result. For example, by designating MS-B (or a node belonging to ISP-B) and pinging it (sending a ping packet), MS-A, based on the contents of a response packet to the ping, can obtain information on whether a packet reaches from MS-A to MS-B (or the node belonging to ISP-B) or not, on how long an RTT (Round Trip Time) is, or the like. In addition, for example, if MS-A designates MS-C (or a node belonging to ISP-C) and traceroutes it, IDs (addresses) of routers on the packet forwarding path from MS-A to MS-C (or the node belonging to ISP-C) can be obtained sequentially, beginning with the one closest to MS-A, and the time taken to reach each router on the path can be found. Using ping, an RTT from a measurement server that sends a ping to a node that receives the ping and back to the measurement server is measured. If measurement servers are synchronized with each other by a GPS or the like, a one-way delay and packet loss on a path from a measurement server that sends a measurement packet to a measurement server that receives the packet can also be measured.

Measurement can be performed using a tool such as pathchar, which can estimate bandwidth provided on a path to a designated node. Using pathchar, as is the way traceroute is performed, addresses of routers on a path in association with information on the time taken to reach there is obtained sequentially, beginning with the one closest to a server in charge of measurement, and this measurement is repeated many times with different sizes of packets to be sent. Then, RTTs for each of the measurement packets of different sizes are measured to determine the regression curve, so that the bandwidth is estimated. The bandwidth can be estimated from the slope of the regression curve, and the propagation delay can be estimated from the RTT at where the packet size is zero, which is indicated by the regression curve.

A presentation server can be installed anywhere (ISP-C, in the example of FIG. 1) in the above internet. A presentation server collects measurement data obtained by a measurement packet transmission like the above from each of the measurement servers, MS-A to MS-G. A user node which desires to be informed of a communication quality of the whole or part of the internet connects to anywhere (ISP-G, in the example of FIG. 1) in the internet, and requests a service from a presentation server. The presentation server then, based on collected measurement data, creates and shows information that matches the user's demand. There is one presentation server in the example of FIG. 1, but a plurality of presentation servers may be installed at a plurality of places in the internet so that information is exchanged and shared between the presentation servers. In this case, for example, the server closest to a user node that submitted a service request will create and show information desired by the user.

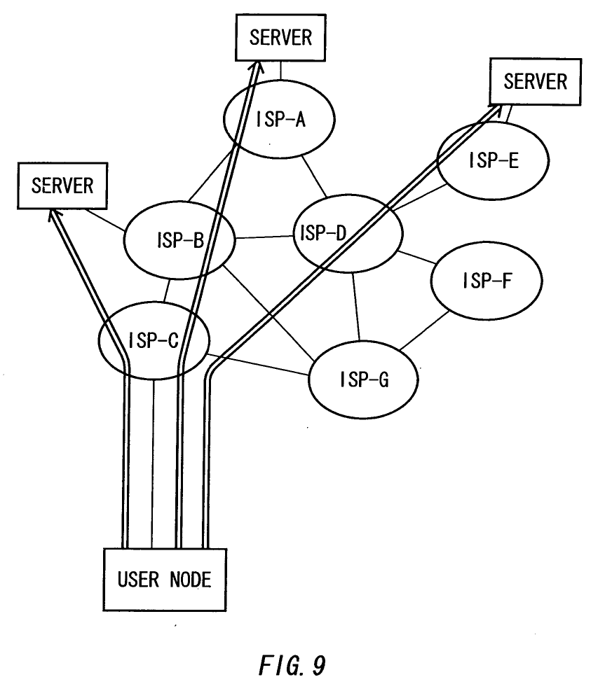

On the other hand, FIG. 9 shows a measurement method for a communication quality that has been conventionally feasible in an internet comprising a plurality of networks similar to FIG. 1. When FIG. 1 is compared with FIG. 9, the advantages provided by the communication quality measurement method consistent with the invention will be apparent. That is, in the conventional method, even though a plurality of servers for measurement could be provided in an internet as shown in FIG. 9, only a throughput from each of the servers to a user node could be obtained when a user requested measurement. Similarly, in the conventional method, only a delay and path from a server could be measured by ping and traceroute from the server to a node. That is, the conventional method could measure only a very limited part of a communication quality provided between an ISP-C connected with a user node and an ISP-A, B, or E in which each server is installed. In contrast, according to the system and method shown in FIG. 1, measurement information including a communication quality provided between many other ISPs can be obtained with a bird's-eye view.

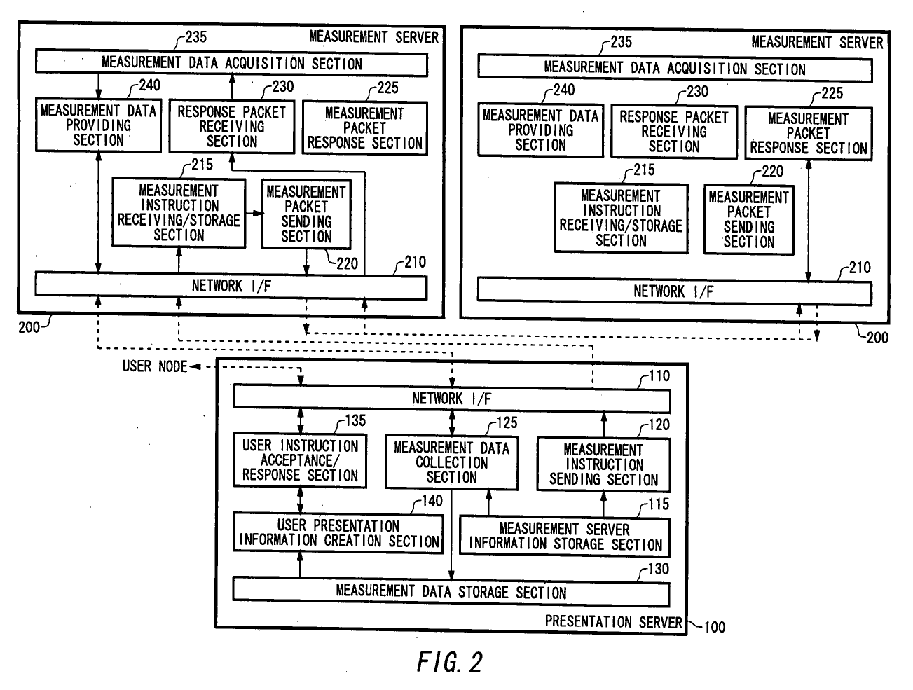

FIG. 2 shows an internal configuration example of a presentation server and measurement servers (MS) of the first embodiment consistent with the invention. The presentation server 100 and each measurement server 200 comprise network I/Fs 110 and 210, respectively, for communication. Each device has one network I/F in the example of FIG. 2, but may have more network I/Fs. The presentation server 100 stores information on the measurement servers (e.g., addresses, ISPs to which they belong, etc.) in a measurement server information storage section 115, and based on the information sends a measurement instruction from a measurement instruction sending section 120 to each measurement server 200. Measurement instructions can include, for example, information on a node to be a destination of a measurement packet, a frequency of sending measurement packets, or the like. The measurement instruction sending section 120 may encrypt a measurement instruction to be sent to each measurement server. Furthermore, authentication information may be added in order to inform a measurement server that the instruction is from a genuine presentation server.

A measurement instruction sent from the presentation server 100 is received and stored by a measurement instruction receiving/storage section 215 of the measurement server 200. The measurement instruction receiving/storage section 215 may decode a received measurement instruction if it is encrypted, and may authenticate whether it is sent from a genuine presentation server or not. A measurement packet sending section 220 of the measurement server 200 sends a measurement packet to a designated destination node at timing according to a stored measurement instruction. In the example of FIG. 2, the other measurement server 200, the destination server, receives this sent measurement packet by means of a measurement packet response section 225, and sends back a response packet. A response packet receiving section 230 of the originating measurement server 200 receives this response packet, and a measurement data acquisition section 235 acquires measurement data (delay, jitter, bandwidth, loss, etc.) from the received response packet and stores the acquired data as required. In a case where a measurement packet is traceroute or the like, not only a destination node (another measurement server, in the example of FIG. 2) but routers on the route send back response packets to a measurement packet, and the response packet receiving section 230 receives these response packets as well. The measurement packet sending section 220 may encrypt a measurement packet to be sent. Moreover, authentication information may be added in order to inform a destination node that the measurement packet is from a genuine measurement server. The response packet receiving section 230 may decode a received measurement packet if it is encrypted, and may authenticate whether it is sent from a genuine measurement server or not.

Acquired measurement data is sent to a measurement data collection section 125 of the presentation server 100 by a measurement data providing section 240 of each measurement server 200. The measurement data providing section 240 may encrypt measurement data to be sent to the presentation server. Moreover, authentication information may be added in order to inform the presentation server that the measurement data is from a genuine measurement server. As for this transmission of measurement data, the measurement data collection section 125 may request measurement data from each measurement server by referring to the measurement server information storage section 115, and the measurement data providing section 240 may, in response to the request, send measurement data stored in the measurement data acquisition section 235 (in this case, a request from the presentation server may be encrypted, and the measurement data providing section 240 may decode the received request and authenticate whether it is sent from a genuine presentation server or not). Alternatively, the measurement data providing section 240 of each measurement server 200 may send measurement data to the presentation server by polling or the like, and the measurement data collection section 125 may receive the data. Data received by the measurement data collection section 125 is stored in a measurement data storage section 130 of the presentation server 100. At this time, the measurement data collection section 125 may, referring to the measurement server information storage section 115, decode the received measurement data if it is encrypted, and may authenticate whether it is sent from a genuine measurement server or not.

On the other hand, a user instruction acceptance/response section 135 of the presentation server 100 accepts from a user node, at any time, an instruction about the presentation of a communication quality of the internet. This instruction about presentation may be in various forms. For example, instructions can be as follows: an instruction for presentation of information on a full-mesh communication quality measured between all the measurement servers; an instruction for presentation of information on a communication quality measured between several measurement servers picked up by a user; an instruction for presentation of measurement information on a quality of communication from a certain measurement server to a node in another network; and an instruction to show information on measurement servers (ISPs to which they belong, etc.) in order of superiority in the communication quality to a node in a certain network. Communication qualities to be requested to be shown may be the whole or a selected part (e.g., delay and jitter only, bandwidth only, etc.) of measured ones. In any case, a user presentation information creation section 140 of the presentation server 100, according to an accepted user instruction, reads measurement data from the measurement data storage section 130 and creates information to be shown. The user instruction acceptance/response section 135 sends back the created presentation information to a user node. The user instruction acceptance/response section 135 may authenticate in order to check whether an instruction from a user node is authorized or not, and decode an instruction from a user node if the instruction is encrypted. Furthermore, the user instruction acceptance/response section 135 may encrypt a response to be sent to a user node.

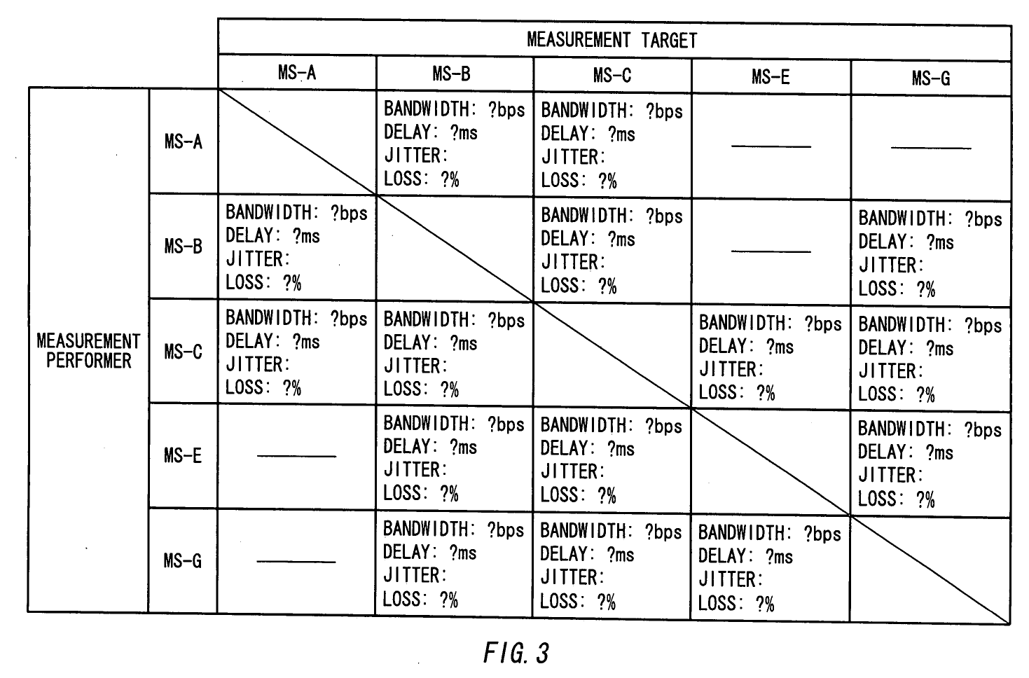

FIG. 3 shows an example of information to be shown as above to a user. Shown in the example of FIG. 3 is information on a full-mesh communication quality measured between all the measurement servers of FIG. 1. Full mesh is shown in a tabular form in which, for example, the rows are a plurality of measurement servers to perform or be in charge of measurement (measurement packet senders) and the columns are a plurality of measurement servers (or routers or hosts) to be measurement targets (measurement packet destinations). Since the example of FIG. 3 corresponds to the example of FIG. 1, measurement is not made between some measurement servers, where dashes are put. Oblique lines are drawn in cells where a server that performs measurement is the same as a measurement target. However, for example, in a case where two or more measurement servers are installed in an identical ISP network (e.g., MS-A1 and MS-A2 are installed in ISP-A), or in a case where a measurement server performs measurement also on a router or host in the same ISP network where the measurement server itself belongs, a communication quality measured inside the same ISP network may be shown instead of an oblique line. When a user, for example, wants to contract with or subscribe to an ISP whose network provides small-delay communication to a certain ISP network (ISP-C), the user chooses MS-C from the measurement targets as a probable communication target ISP so that the user can choose, as the ISP for contract or subscription, an ISP to which a server (e.g., MS-G) that provides the least delay for MS-C belongs, among the servers that perform measurement, MS-A to MS-G, in the table in FIG. 3. Conversely, when a user wants to contract with or subscribe to an ISP whose network provides a large bandwidth for communication from a certain ISP network (ISP-B), the user chooses MS-B from the servers that perform measurement as a probable communication source ISP so that the user can choose, as the ISP for contract or subscription, an ISP to which a measurement target (e.g., MS-G) that provides the largest bandwidth for MS-B belongs, among the measurement targets, MS-A to MS-G, in the table in FIG. 3.

In the example of FIG. 3, since an end-to-end communication quality between measurement servers is to be shown, measurement information can be obtained by, for example, ping itself. When traceroute is performed, additional information regarding which path provides each communication quality can be obtained. In this case, the presentation server 100 may show path information to a user in addition to the information in FIG. 3. For example, if a user is shown that a quality of communication from MS-A to MS-B (suppose relatively small bandwidth is displayed) is provided by a path from [ISP-A] to [ISP-B] and that a quality of communication from MS-A to MS-C (suppose relatively large bandwidth is displayed) is provided by a path from [ISP-A] via [ISP-D] and [ISP-G] to [ISP-C], the user can understand that relatively large bandwidth can be secured for communication from ISP-A to ISP-D but only relatively small bandwidth can be secured for communication from ISP-A to ISP-B.

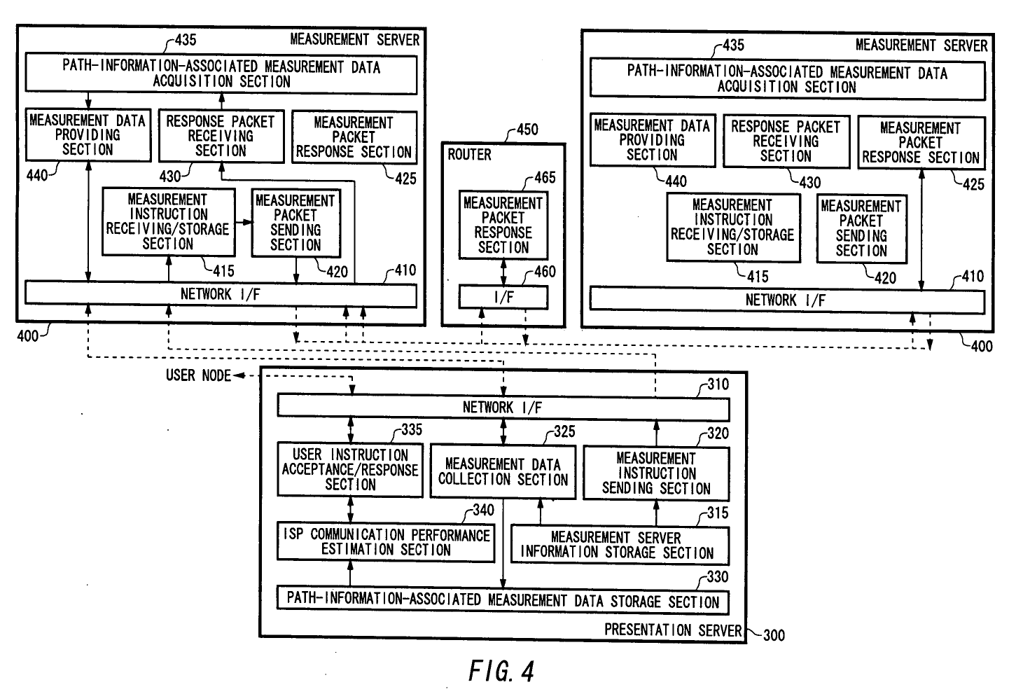

In the second embodiment consistent with the invention, a presentation server estimates a communication quality of each ISP network by using path information as above and shows the estimated result to a user. An internal configuration example of a presentation server and measurement servers (MS) in this case is shown in FIG. 4. Since the measurement server in FIG. 4 acquires path information as well as measurement data, a router that sends back measurement information in response to a measurement packet is also shown in FIG. 4. Though one router is shown in FIG. 4, a plurality of similar routers may exist on a path in an actual internet. The presentation server 300, each measurement server 400, and each router 450 comprise (one or more) network I/Fs 310, 410, and 460, respectively, for communication.

A measurement server information storage section 315 and measurement instruction sending section 320 of the presentation server 300, and a measurement instruction receiving/storage section 415, measurement packet sending section 420, and measurement packet response section 425 of each measurement server 400 are similar to 115, 120, 215, 220, and 225 of the first embodiment (FIG. 2), respectively. Since many of the other functions shown in FIG. 4 are in common with the first embodiment, the description below will center on differences.

In FIG. 4, in response to a measurement packet sent from the measurement packet sending section 420 of one measurement server 400, not only the measurement packet response section 425 of the other measurement server 400 of destination, but also a measurement packet response section 465 of the router 450 sends back a response packet. A response packet receiving section 430 of the originating measurement server 400 receives response packets from a destination node and all the routers on the path, and a path-information-associated measurement data acquisition section 435 acquires path information (a router address) and measurement data (delay, jitter, bandwidth, loss, etc.) from received response packets and stores them as required. Acquired path-information-associated measurement data is sent to a measurement data collection section 325 of the presentation server 300 by a measurement data providing section 440 of each measurement server 400, and stored in a path-information-associated measurement data storage section 330.

On the other hand, a user instruction acceptance/response section 335 of the presentation server 300 accepts from a user node, at any time, an instruction about the presentation of a communication quality of the internet. This instruction about presentation may be in various forms. For example, in a case where a user who wants to connect to the internet is considering which ISP is the best for the user to contract with or subscribe to, the user can request presentation of information on what communication quality is provided by an ISP network under consideration on each of a plurality of ISP networks assumed as communication targets. Alternatively, a user can request presentation of information on what quality is provided on communication from a network, to which a certain communication target belongs, to each of a plurality of ISP networks. Communication qualities to be requested to be shown may be the whole or a selected part (e.g., delay and jitter only, bandwidth only, etc.) of measured ones. In any case, an ISP communication performance estimation section 340 of the presentation server 300, according to an accepted user instruction, reads path information and measurement data from the path-information-associated measurement data storage section 330 and estimates a communication performance of a designated ISP network. The user instruction acceptance/response section 335 sends back estimated information to a user node as presentation information. In this example, a presentation server performs a process of estimating a communication performance of each network based on path-information-associated measurement data. Alternatively, each measurement server may perform an estimation process on a part that the measurement server can estimate based on path-information-associated measurement data acquired by itself, and the estimation result may be collected from each measurement server to a presentation server so that the presentation server selects a communication performance of a network designated by a user from the collected estimation results and shows it to the user.

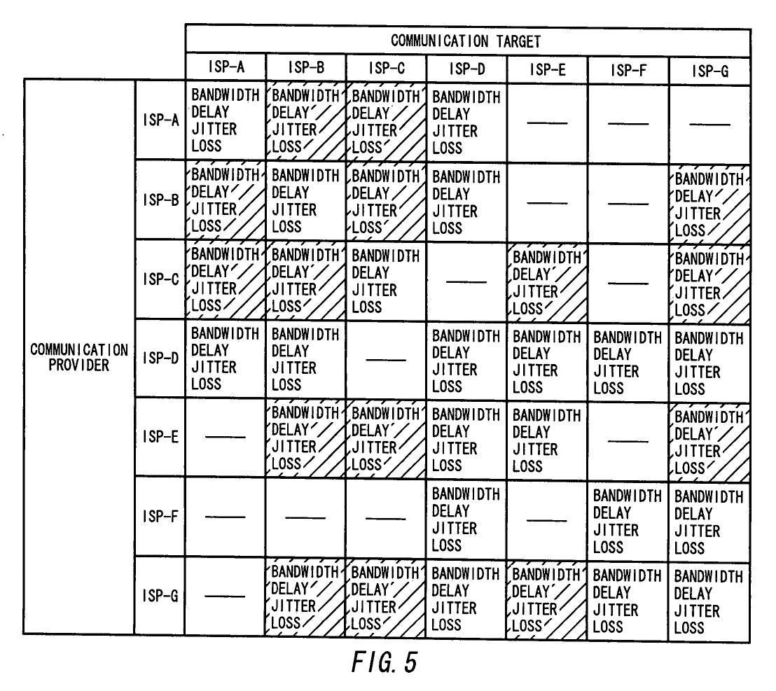

FIG. 5 shows an example of information to be shown to a user as above. In the example of FIG. 5, information on estimated communication performances between all the ISP networks in FIG. 1 is shown in a tabular form in which the rows are a plurality of ISP networks under consideration as a communication provider for contract or subscription and the columns are a plurality of ISP networks considered as a probable communication target. Also in the example of FIG. 5, information on a communication quality to be obtained directly by measurement between measurement servers (this correspond to the information shown in FIG. 3) is emphasized in a shaded cell, and information on a communication quality to be estimated based on the measurement results are shown in an ordinary face. Additionally, in the example of FIG. 5, a communication quality between neighboring ISP networks in the network configuration in FIG. 1 and a communication quality in the same ISP network are estimated and shown. The above estimation can be performed, for example, as follows.

A case is explained below where information on each communication quality along a path from [ISP-E], via a border router ED, [ISP-D], and a border router DG, to [ISP-G] is obtained by measurement (traceroute etc.) from MS-E to MS-G. A quality to be provided on communication in ISP-E is estimated based on a measurement result of a quality of communication from MS-E to the border router ED. A quality to be provided on communication from ISP-E to ISP-D is estimated based on a measurement result of a quality of communication from MS-E to the border router DG as well as measurement results for parts of that route. Similarly, a quality to be provided on communication from ISP-D to ISP-G is estimated based on a measurement result of a quality of communication from MS-E to MS-G and measurement results for parts of that route. In another case where information on each communication quality on a path from [ISP-E], via a border router ED, [ISP-D], and a border router DB, to [ISP-B] is obtained by measurement from MS-E to MS-B, a quality to be provided on communication in ISP-E, a quality to be provided on communication from ISP-E to ISP-D, and a quality to be provided on communication from ISP-D to ISP-B can be estimated based on the obtained information. In these cases, two (or more) estimation results, an estimation result based on measurement from MS-E to MS-G and an estimation result based on measurement from MS-E to MS-B, are obtained for each of a communication quality in ISP-E and a communication quality from ISP-E to ISP-D. A communication quality may be shown by averaging these results, or each estimation result may be shown with information on which measurement result the estimation is based on.

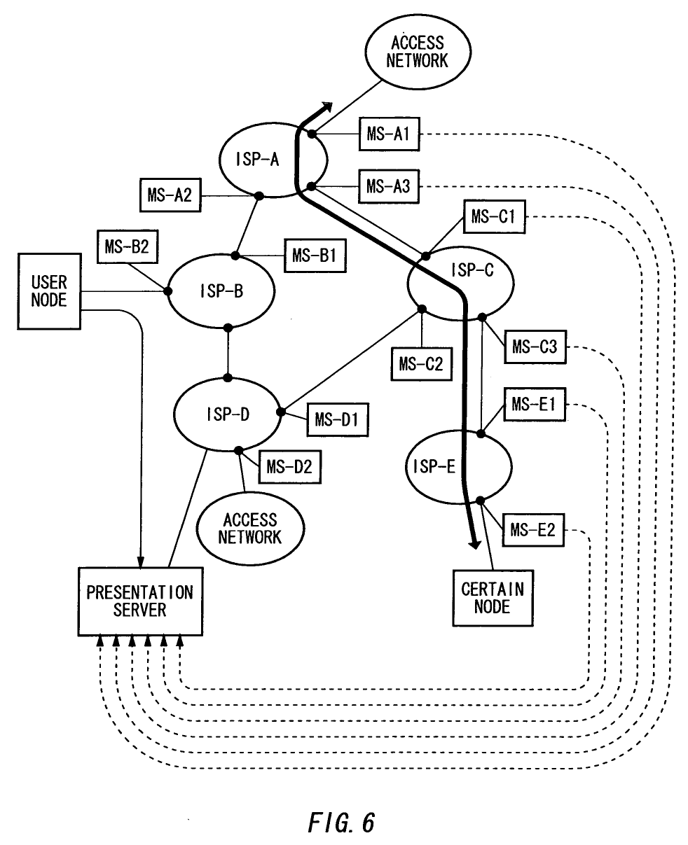

FIG. 6 illustrates a network configuration to which a third embodiment consistent with the invention may be applied. ISP-A through ISP-E represent ISP networks, and there are many routers (not shown) in each network to provide IP (Internet Protocol) communication. The ISP networks are connected to each other also by the IP (Internet Protocol). In the figure, one line schematically signifies a connection between ISP networks. This does not necessarily mean that networks are connected to each other by a physical link, but includes a case where a connection is provided by another network at the back including many routers not shown. Additionally, though each network is of ISPs different from each other in the example of FIG. 6, some or all of the ISPs, ISP-A to ISP-E, may be operated by the same ISP-X, and each of the some or all of the networks A to E may correspond to an area in ISP-X defined by the OSPF or other routing protocols. Moreover, each of the networks A to E does not necessarily have clear borders topologically between itself and another network. The extent or border of each network can be defined as a user likes.

Measurement servers MS-A1 to A3, MS-B1 and B2, MS-C1 to C3, MS-D1 and D2, and MS-E1 and E2 are installed in this internet. Two or more measurement servers are installed in each ISP network in the example of FIG. 6, but the number may be one, or there may be a network provided with no measurement server. In addition, the measurement servers are installed on borders of each ISP network in the example of FIG. 6, but measurement servers may be installed inside each ISP network. In the third embodiment, each measurement server is desirably implemented on a router having a packet forwarding function. For example, MS-A1 of FIG. 6 is provided on a router that performs packet forwarding between an access network and ISP-A, and MS-A2 is provided on a router that performs packet forwarding between ISP-A and ISP-B. Each of these measurement servers measures a communication quality by sending and receiving a measurement packet to and from an adjacent measurement server. Therefore, a communication quality of a measurement section can be investigated for each of its many sub-sections (e.g., also for a path further divided into sub-sections within one network) if many measurement servers are densely provided in the internet, but if measurement servers are sparsely provided (e.g., one sub-section includes more than one networks), less information will be obtained accordingly on a communication quality for each sub-section.

A measurement server performs so-called active measurement in which test traffic (ping, traceroute, etc.) is sent and received so that measurement information is obtained as a result. For example, MS-A1 designates and pings neighboring MS-A2 and MS-A3 severally, and obtains communication quality information based on a response packet to the ping. Additionally, MS-A2 designates and pings neighboring MS-A1 and MS-B1 severally, and MS-A3 designates and pings neighboring MS-A1 and MS-C1 severally.

Also in this example, a presentation server can be installed anywhere (ISP-D, in the example of FIG. 6) in the above internet. The presentation server receives from a user node a service request including designation of a start point and an end point of a section whose communication quality the user wants to know (in the example of FIG. 6, from a connecting point between ISP-A and the access network to a certain node connected to ISP-E). This user node can connect to anywhere (ISP-B, in the example of FIG. 6) in the internet to request a service. Since routing information in the internet is collected in the presentation server, the presentation server finds using this routing information a path through which a packet is forwarded from the designated start point to the end point. The routing information here can be obtained by various methods. For example, it can be obtained by traceroute, or can be obtained directly from the OSPF, ISIS, BGP, or other routing protocols. In the former method, for example, traceroute is executed in response to a service request from a user. In the latter method, current routing information is retained in a routing protocol, and a service request from a user can be processed using this information obtained in advance, so that presentation to a user can be quick.

The presentation server then requests measurement servers existing on the found path (MS-A1, MS-A3, MS-C1, MS-C3, MS-E1, and MS-E2, in the example of FIG. 6) to send measurement data obtained by measurement packet transmission as described above. Each transmission request may include designation of a measurement server corresponding to the next step on the path (MS-A3 is designated for MS-A1, MS-C1 is designated for MS-A3, and so forth), and each measurement server may select measurement data on the designated adjacent measurement server and send the selected data to the presentation server. The presentation server then, based on the collected measurement data, shows the user node a communication quality of each of a plurality of sub-sections that are divided from the section designated by the user. The sub-sections here are between each adjacent measurement server (five sub-sections divided by the above six MSs, in the example of FIG. 6).

An example is described above in which a presentation server, after receiving an instruction on a section from a user node, requests measurement data from each measurement server corresponding to the instruction. Alternatively, the presentation server may collect measurement data from all the measurement servers on a regular basis so that the presentation server, when receiving an instruction on a section from a user node, can select corresponding data from pieces of measurement data collected just before the instruction and show the selected data. In either case, a communication quality is not measured by actually sending a measurement packet from a start point to an end point of a section relating to a service request made by a user node, after the service request is made. Instead, a measurement result is shown by selecting required pieces of information from information on a communication quality having been measured in the background for each sub-section and by combining them. For this reason, there is no case where measurement traffic is generated over a long section every time a service request is made by each of many users, and thus the third embodiment has a good scalability also.

A section from an access network to a certain node happened to be designated in the example of FIG. 6, but any point in the internet can be designated as both a start point and an end point of a section. In addition, a section of one-to-one communication is designated in the example of FIG. 6, but a section of one-to-many (multicast) communication and a section of many-to-one (aggregate) communication can also be designated. In the one-to-many and the many-to-one, similarly to the case of one-to-one, a packet forwarding path is found and each measurement server on the path is identified to obtain measurement data. Moreover, both directions of communication over a designated section are along the same path in the example of FIG. 6, but the embodiment functions as it is when the both directions are different from each other. That is, an outgoing path from a start point to an end point, which are designated, and a return (incoming) path from the end point to the start point will be found separately from each other, and then measurement servers on each path will be identified. In addition, if a user wants to know a communication quality for only one direction, measurement data will be collected for only the one direction.

In a case where, in contrast to the example of FIG. 6, measurement servers MS-A, MS-C, and MS-E, for example, are installed inside ISP-A, inside ISP-C, and at an exit of ISP-E, respectively and if the same section is designated as is in FIG. 6, three measurement servers MS-A, MS-C, and MS-E are identified, and a communication quality is shown for two sub-sections between MS-A and MS-C and between MS-C and MS-E. Also in this case, all the ISPs, ISP-A to ISP-E, may be networks A to E operated by the same ISP. Moreover, there is one presentation server in the example of FIG. 6 as is the case with FIG. 1, but a plurality of presentation servers may be installed at a plurality of places in the internet so that information is exchanged and shared between the presentation servers.

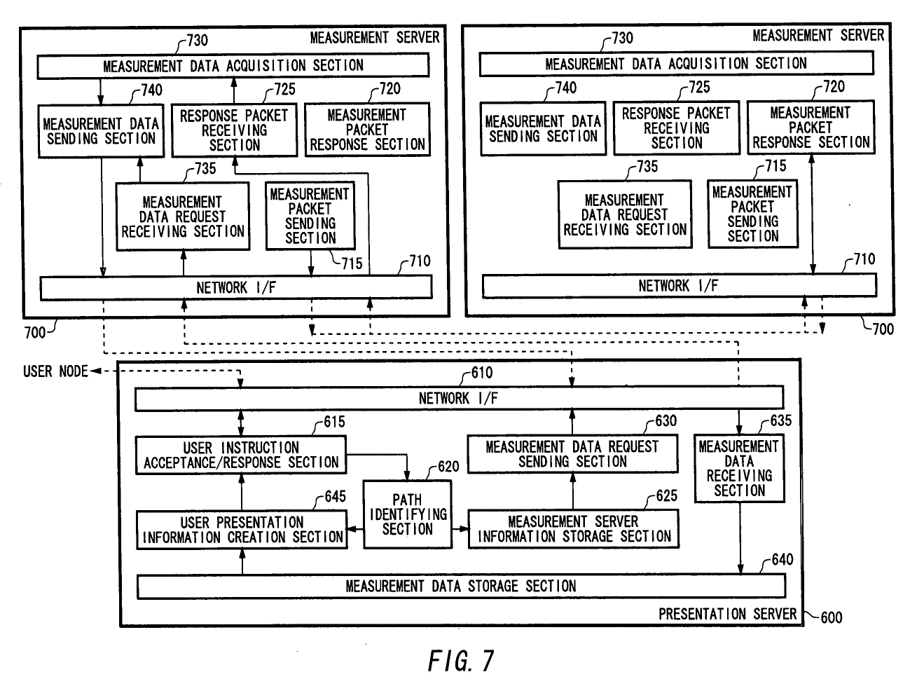

FIG. 7 shows an internal configuration example of a presentation server and measurement servers (MS) of the third embodiment consistent with the invention. Shown in FIG. 7 is a case where the presentation server, after receiving an instruction on a section from a user node, requests measurement data from an identified measurement server. Alternatively, in a case where a presentation server collects measurement data from all measurement servers and stores the data on a regular basis so that the presentation server, in response to an instruction from a user node, selects and shows corresponding data, the internal configuration of FIG. 7 can be changed appropriately with reference to FIG. 2. The presentation server 600 and each measurement server 700 comprise (one or more) network I/Fs 610 and 710, respectively, for communication.

A measurement packet sending section 715 of the measurement server 700 stores an address of the neighboring measurement server 700, and sends a measurement packet to the stored address on a regular basis. The neighboring measurement server 700, the destination server, receives this sent measurement packet by means of a measurement packet response section 720, and sends back a response packet. A response packet receiving section 725 of the originating measurement server 700 receives this response packet, and a measurement data acquisition section 730 acquires measurement data (delay, jitter, bandwidth, loss, etc.) from the received response packet and stores the acquired data. In FIG. 7, measurement is shown for only one direction for illustrative purposes. Actually, however, since the two measurement servers 700 in the figure are adjacent to each other, measurement may be also made for the reverse direction, and measurement between them and another neighboring measurement server may also be made for both directions. The measurement packet sending section 715 may encrypt and send a measurement packet. Moreover, it may add authentication information in order to inform a destination node that the measurement packet is from a genuine measurement server. The response packet receiving section 725 may decode a received measurement packet if it is encrypted, and may authenticate whether it is sent from a genuine measurement server or not.

On the other hand, a user instruction acceptance/response section 615 of the presentation server 600 accepts from a user node, at any time, an instruction about a section whose communication quality the user wants to know. This instruction about a section includes information on a start point and information on an end point. A path identifying section 620 of the presentation server 600 then finds a packet forwarding path from the start point to the end point, and information on a measurement server existing on the path (e.g., an address of the measurement server, etc.) is read from a measurement server information storage section 625. A measurement data request sending section 630 then sends a measurement data request, using the read information on the measurement server for the destination. A measurement data request to be sent to a measurement server may include information on a measurement server on the next step to the measurement server which is found by the path identifying section 620. Moreover, the measurement data request sending section 630 may encrypt a request to be sent to each measurement server. Furthermore, authentication information may be added in order to inform a measurement server that the instruction is from a genuine presentation server.

This measurement data request is received by a measurement data request receiving section 735 of a destination measurement server 700, and a measurement data sending section 740 of the measurement server 700 reads requested measurement data from the measurement data acquisition section 730 and sends the measurement data. The measurement data request receiving section 735 may decode a received request if it is encrypted, and may authenticate whether it is sent from a genuine presentation server or not. The measurement data sending section 740 may encrypt and send measurement data. Moreover, authentication information may be added in order to inform a presentation server that the measurement data is from a genuine measurement server. A measurement data receiving section 635 of the presentation server 600 then receives measurement data from the measurement server 700, and also receives measurement data from the measurement server 700 on the next step, although an arrow is omitted from illustration in the figure. At this time, the measurement data receiving section 635 may, referring to the measurement server information storage section 625, decode the received measurement data if it is encrypted, and may authenticate whether it is sent from a genuine measurement server or not. Received measurement data is stored in a measurement data storage section 640 for a time, and is read by a user presentation information creation section 645 along the path found by the path identifying section 620. Based on read measurement data, information to be shown is created, and is sent back to a user node by the user instruction acceptance/response section 615. As is the case with the first and second embodiments, authentication and/or encryption may be performed between a user node and the presentation server.

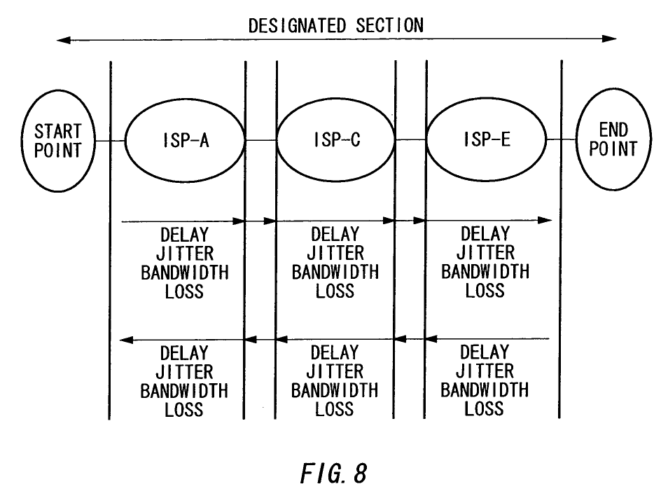

FIG. 8 shows an example of information that is shown to a user as above. In the example of FIG. 8, corresponding to the example of FIG. 6, communication qualities of five sub-sections between a designated start point and a designated end point are shown for both directions. The five sub-sections are: the inside of ISP-A; an area between ISP-A and ISP-C; the inside of ISP-C; an area between ISP-C and ISP-E; and the inside of ISP-E. As for each of the other examples described in association with FIG. 6, information suited to each one will of course be shown. For example, in a case where an outgoing path is different from a return path, the return path and its sub-sections are shown separately. Also in a case where, unlike FIG. 8, sub-sections are not clear because a measurement server inside a network is used or because a plurality of networks are put between neighboring measurement servers, only information on measurement servers may be shown in turn from a start point to an endpoint, without touching on what exists in each sub-section, in a form of communication qualities between each neighboring measurement servers.

A presentation example in a case where one section is designated is shown in FIG. 8, but a user node can designate a plurality of sections at once. For example, as shown in the example of FIG. 5, when a quality of communication from one network to each of a plurality of networks that are probable communication targets or a quality of communication from each of a plurality of networks to one network that is a probable communication target is desired to be investigated, start points and end points will be designated as many as required for each case. As for presentation to a user in these cases, a plurality of designated sections may be shown in a form like FIG. 8, or information in a tabular form like FIG. 5 may be created and shown.

In the above-described embodiments, each section of the device configurations shown in FIGS. 2, 4, and 7 may be implemented by software, hardware, or combination of them.

Using the above-described systems and methods consistent with the invention, an Internet measurement-service provider, for example, can carry out a service in which the provider installs measurement servers in each ISP network, collects measurement information on a communication quality from these measurement servers to a presentation server operated by the provider, and informs a user of a communication quality of the Internet in accordance with the user's request. The user of this service carried out by the measurement-service provider can enjoy the following benefits.

First, in a case where a manager of a user network or an individual is a user of the above measurement service, the user can select more appropriately which ISP to use for an Internet connection and which ISP to contract, by finding a communication quality provided in the Internet. In a case where a user has already been connected to the Internet and is allowed to designate a forward path of a packet to be sent from a user node, the user node can select a path so that a packet is to be forwarded via an ISP that provides a communication quality more suitable for the user's communication. Also in a case where a user node is in multi-home connection, the user can select which ISP to use for connecting to the Internet, at the time of sending a packet. Moreover, a user can also verify whether a guaranteed service level of an SLA with a contracted ISP is actually provided or not.

In a case where a manager of an ISP is a user of the above measurement service, the manager can select more appropriately which ISP to use as an upstream ISP of the manager's own ISP network (transit service) or which ISP to use for peering with the manager's own ISP network, by finding a communication quality provided on the Internet other than the manager's own ISP network. In addition, when a packet whose destination is the outside comes into the manager's own ISP network, the ISP network can select a path so that the packet is to be forwarded via an ISP that provides a communication quality more suitable for the forwarded communication. Moreover, if the manager's own ISP adopts an SLA that guarantees a quality of communication with another ISP network, the manager can verify whether the manager's own ISP actually keeps observing the SLA or not.

Furthermore, in a case where a provider that installs a server in the Internet and provides a communication service (e.g., a content service) for its client is a user of the above measurement service, by, for example, providing a plurality of content delivery servers so that they are connected to ISPs different from each other and by finding a communication quality provided on the Internet, the provider can select a delivery server that can provide the best communication quality to each of the clients that are connected to various ISPs and request a content, and can send a content to the client from the selected delivery server. Additionally, as inventers of the present invention proposed in Japanese Patent Applications No. 2003-323610 and No. 2003-323667, there may be a provider that provides a service in which the provider installs a server and/or a router in the Internet and, when forwarding a packet to a client that is in multi-home connection, selects which link provided by which ISP is to be used for the forwarding, based on a communication quality provided by each ISP. This type of multi-home service provider may be a user of the above measurement service as well as a content service provider.

Systems and methods consistent with the invention can be used even without the above measurement-service provider. For example, a manager of an internetwork such as an ISP network, a regional network, a corporate network, or the like can install its own measurement servers in each of a plurality of networks managed by one manager, and perform its own measurement service. In particular, the third embodiment, which shows a communication quality for each sub-section, is also useful for a case where, for example, a quality of communication from a start point at Tokyo to an end point at Kobe is to be investigated in a wide-area ISP network for each of sub-sections: Tokyo-Nagoya; Nagoya-Osaka; and Osaka-Kobe. In this case, the manager of the wide-area ISP network is a user of its own measurement service, and its own measurement servers at Tokyo, Nagoya, Osaka, and Kobe correspond to measurement servers installed in each of a plurality of networks consistent with the invention.

Persons of ordinary skill in the art will realize that many modifications and variations of the above embodiments may be made without departing from the novel and advantageous features of the present invention. Accordingly, all such modifications and variations are intended to be included within the scope of the appended claims. The specification and examples are only exemplary. The following claims define the true scope and spirit of the invention.

1. A measurement system connected with a plurality of networks, comprising:
a plurality of measurement servers, each of which is located at each of the plurality of networks; and
a presentation server that collects information from the plurality of measurement servers and shows the information to a user,
wherein
each of the plurality of measurement servers includes:
a first transmitting unit that transmits a measurement packet toward a node belonging to another of the plurality of networks;
an acquiring unit that acquires information regarding a quality of communication with the node based on a response to the measurement packet; and
a second transmitting unit that transmits to the presentation server the information acquired, and
the presentation server includes:
a receiving unit that receives the information transmitted from each of the plurality of measurement servers; and
an informing unit that informs the user of a communication quality in accordance with an instruction from the user, based on the information received.

2. The measurement system according to claim 1, wherein
the informing unit informs the user of a quality provided on communication starting from each of the plurality of measurement servers as the communication quality.

3. The measurement system according to claim 1, wherein
the information acquired by the acquiring unit and the information transmitted from each of the plurality of measurement servers include information regarding a path of packet forwarding, and
the informing unit further estimates a communication performance of a network indicated among the plurality of networks by the user, based on the information received, to inform the user of the estimated performance as the communication quality.

4. The measurement system according to claim 1, wherein
the information acquired by the acquiring unit includes information regarding a path of packet forwarding,
the acquiring unit further estimates a communication performance of one or more of the plurality of networks, based on the information acquired, and
the second transmitting unit transmits to the presentation server the communication performance estimated by the acquiring unit as the information acquired.

5. The measurement system according to claim 1, wherein
the information received by the receiving unit includes information transmitted from one or more of the plurality of measurement servers that exist on a path of packet forwarding within a measurement section indicated by the user, the measurement section being divided into sub-sections that form the path, and
the informing unit that informs the user of a quality of communication for each of the sub-sections, based on the information received.

6. The measurement system according to claim 5, wherein the presentation server further comprises
an identifying unit that identifies said one or more of the plurality of measurement servers such that the receiving unit receives information transmitted from the identified one or more of the plurality of measurement servers.

7. The measurement system according to claim 1, wherein
each of the plurality of measurement servers selects another of the plurality of measurement servers as the node belonging to said another of the plurality of networks.

8. The measurement system according to claim 7, wherein
one or more of the plurality of measurement servers are located at each of the plurality of networks, and
the first transmitting unit transmits a measurement packet toward another of the plurality of measurement servers that is located at a same or different network among the plurality of networks.

9. The measurement system according to claim 1, wherein
the plurality of measurement servers transmit information regarding a quality of communication to the presentation server, by turns or periodically.

10. The measurement system according to claim 1, wherein
the presentation server selects one or more of the plurality of measurement servers in accordance with an instruction from the user, and transmits a request for information regarding a quality of communication to the selected one or more of the plurality of measurement servers, and
the plurality of measurement servers transmit information regarding a quality of communication to the presentation server, in response to the request from the presentation server.

11. The measurement system according to claim 1, wherein
communication between the presentation server and each of the plurality of measurement servers is associated with at lease one of authentication and encryption.

12. A presentation server included in a measurement system connected with a plurality of networks, comprising:
a communication unit that communicates with a plurality of measurement servers, each of which is located at each of the plurality of networks;
a receiving unit that receives, via the communication unit, information regarding a quality of communication from each of the plurality of measurement servers, the information being acquired based on a response to a measurement packet transmitted from each of the plurality of measurement servers toward a node belonging to another of the plurality of networks; and
an informing unit that informs a user of a communication quality in accordance with an instruction from the user, based on the information received by the receiving unit.

13. The presentation server according to claim 12, wherein
the informing unit informs the user of a quality provided on communication starting from each of the plurality of measurement servers as the communication quality.

14. The presentation server according to claim 12, wherein
the information received by the receiving unit includes information regarding a path of packet forwarding, and
the informing unit further estimates a communication performance of a network indicated among the plurality of networks by the user, based on the information received, to inform the user of the estimated performance as the communication quality.

15. The presentation server according to claim 12, wherein
the information received by the receiving unit includes information transmitted from one or more of the plurality of measurement servers that exist on a path of packet forwarding within a measurement section indicated by the user, the measurement section being divided into sub-sections that form the path, and
the informing unit that informs the user of a quality of communication for each of the sub-sections, based on the information received.

16. A measurement method performed in a measurement system connected with a plurality of networks, the measurement system including a plurality of measurement servers and a presentation server, comprising:
transmitting, by at least one of the plurality of measurement servers, a measurement packet toward a node belonging to another of the plurality of networks, each of the plurality of measurement servers being located at each of the plurality of networks;
acquiring, by said at least one of the plurality of measurement servers, information regarding a quality of communication with the node based on a response to the measurement packet;
receiving, by the presentation server, information from said at least one of the plurality of measurement servers; and
informing, by the presentation server, a user of a communication quality in accordance with an instruction from the user, based on the received information.

17. The method of claim 16, wherein
a quality provided on communication starting from each of the plurality of measurement servers is informed to the user as the communication quality.

18. The method of claim 16, wherein
the acquired information includes information regarding a path of packet forwarding, and the method further comprising
estimating, by the presentation server or at least one of the plurality of measurement servers, a communication performance of a network indicated among the plurality of networks by the user, based on the acquired information, to inform the user of the estimated performance as the communication quality.

19. The method of claim 16, wherein
the received information includes information from one or more of the plurality of measurement servers that exist on a path of packet forwarding within a measurement section indicated by the user, the measurement section being divided into sub-sections that form the path, and
a quality of communication for each of the sub-sections is informed to the user as the communication quality.

20. A computer usable medium having computer readable program codes embodied therein for a computer functioning as a presentation server included in a measurement system connected with a plurality of networks, the computer readable program codes comprising:
a communication code module causing the computer to communicate with a plurality of measurement servers, each of which is located at each of the plurality of networks;
a receiving code module causing the computer to receive information regarding a quality of communication from each of the plurality of measurement servers, the information being acquired based on a response to a measurement packet transmitted from each of the plurality of measurement servers toward a node belonging to another of the plurality of networks; and
an informing code module causing the computer to inform a user of a communication quality in accordance with an instruction from the user, based on the information received.
